(19) United States
(12) Patent Application Publication
(10) Pub. No.: US 2006/0045640 A1
(43) Pub. Date: Mar. 2, 2006

(54) Support pads for drill heads

(75) Inventor: Ingemar Hessman, Sandviken (SE)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: SANDVIK INTELLECTUAL PROPERTY AB, Sandviken (SE)

(21) Appl. No.: 11/156,736

(22) Filed: Jun. 21, 2005

(30) Foreign Application Priority Data
Jun. 21, 2004 (SE) 0401597-0

(51) Int. Cl. B23B 51/00

(52) U.S. Cl. 408/81

(57) ABSTRACT

The present invention relates to a drill head comprising one or more support pads. According to the invention at least one support pad is made of a ceramic material. Such a support pad is particularly useful when drilling in heat resistant materials such as Inconel 718, Inconel 939, Waspaloy, Udimet 720, etc.

### BACKGROUND OF THE INVENTION

The present invention relates to support pads for drill heads, in particular for long hole drilling in heat resistant steel materials. According to the invention, the pads are made of ceramic materials.

Drilling in metals is generally divided in two types: long hole drilling and short hole drilling. Short hole drilling means generally drilling to a depth of up to 3-5 times the drill diameter. Long hole drilling means generally drilling to many more times the drill diameter.

With short hole drilling, the demands are not as great and therefore simple helical drills made of solid cemented carbide, solid tool steel or tool steel equipped with cemented carbide inserts are used.

Long hole drilling, however, puts large demands on good chipbreaking, lubrication, cooling and not the least chip transport. This is achieved through specially developed drilling systems with specially designed drill heads connected to a drill rod and which fulfills the above mentioned requirements. The drilling head may be of solid cemented carbide but is generally made of tool steel or cast steel, provided with a number of inserts of cemented carbide placed in such a way that they together form the desired cutting edge. Such long hole drills are known in the art.

The design of the long hole drilling head is such that the cutting forces are not balanced. Therefore, in order to absorb the resulting radial cutting forces, the drilling head is generally provided with support pads mechanically clamped to the head to support and guide the head during operation. Inserts and support pads are generally made of cemented carbide with different contents of WC, Co and cubic carbides TiC, TaC, NbC depending on the application. The support pads are, in addition, often coated with one or more wear resistant layers. Generally the support pads are coated with a yellow layer of TiN or WC/C+TiAlN.

However, when machining heat resistant steel superalloys such as Inconel 718, Inconel 939, Waspaloy, Udimet 720, etc., support pads of coated cemented carbide tend to become covered with a network of small cracks which leads to rapid wear and too frequent change of support pads.

In EP 0713747, the use of a coated ceramic guide member for a reamer is disclosed. The coating is boron nitride or diamond. A similar reamer with a guide strip which contains aluminum oxide and titanium carbide is disclosed in EP 0410342. Reamers are used for finishing of pre-formed holes and are not subjected to the same type of forces as drills for long hole drilling. [NOTE: Are there other distinguishing characteristics between reamers and long hole drills which can be added?]

### OBJECTS AND SUMMARY OF THE INVENTION

It is therefore an object to provide a support pad which is strong and durable particularly when long hole drilling in heat resistant materials.

In one aspect of the invention, there is provided a long hole drill head comprising one or more support pads wherein at least one support pad is made of a ceramic material.

In another aspect of the invention, there is provided the use of a long hole drill head of the present invention for drilling in heat resistant superalloy materials.

### BRIEF DESCRIPTION OF THE FIGURE

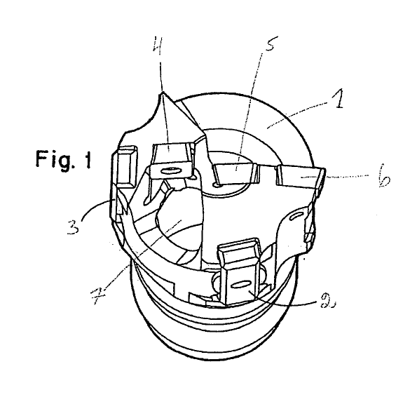

FIG. 1 is a perspective view of an example of a drilling head provided with support pads in which
1=drilling head of the Ejector® type
2 and 3=support pads
4=central cutting insert
5=intermediate cutting insert
6=peripheral cutting insert
7=internal cooling channel

### DETAILED DESCRIPTION OF A PREFERRED EMBODIMENT OF THE INVENTION

As may be seen in FIG. 1, the cutting inserts 4, 5 and 6 are clamped or brazed on the drill head. The peripheral insert 6 forms the diameter of the hole in the workpiece that is machined. The central insert 4 overlaps the central axis of the drill, as no remaining core is desired. During rotation, the orbit of the cutting edge of the intermediate insert 5 overlaps with the cutting edges of both the peripheral insert 5 and the intermediate insert 6 to thereby obtain a continuous cutting line from the central axis to the periphery.

In the usual manner, the drill head 1 is provided with an interior central channel 7, through which the major part of the chips are expelled.

According to the present invention, there is provided a drill head with at least one support pad of a ceramic material wherein the pad includes a base body with a bottom surface, at least one side surface and a top surface. In a preferred embodiment, the support pad is 180° indexable.

In a first embodiment, the ceramic material is essentially ceramic oxides or ceramic oxides mixed with hard carbides and/or nitrides and/or borides and/or binder metal and conventional pressing and/or sintering aids. In a preferred embodiment, the ceramic material is oxide based, preferably consisting essentially of Al₂O₃ and/or ZrO₂.

In a second embodiment, the ceramic material is nitride based containing conventional pressing and/or sintering aids. In a preferred embodiment, the nitride based material consists essentially of Si₃N₄ and intergranular phase. In another preferred embodiment, the ceramic material consists of α- and/or β-sialon and intergranular phase.

In a third embodiment, the ceramic material further contains whisker and/or platelets, preferably of SiC.

The support pads according to the invention can be provided with a wear resistant coating as known in the art, e.g., TiN or WC/C and TiAlN.

The invention also relates to the use of a drill head provided with at least one support pad of a ceramic material for drilling in heat resistant materials such as Inconel 718, Inconel 939, Waspaloy, Udimet 720 etc.

The principles, preferred embodiments and modes of operation of the present invention have been described in the foregoing specification. The invention which is intended to be protected herein, however, is not to be construed as limited to the particular forms disclosed, since these are to be regarded as illustrative rather than restrictive. Variations and changes may be made by those skilled in the art without departing from the spirit of the invention.

What is claimed is:

1. Long hole drill head comprising one or more support pads wherein at least one support pad is made of a ceramic material.

2. The long hole drill head according to claim 1 wherein said ceramic material consists essentially of ceramic oxides, ceramic oxides mixed with hard carbides and/or nitrides and/or borides and/or binder metal and conventional pressing and/or sintering aids.

3. The long hole drill head of claim 2 wherein said ceramic material is oxide based.

4. The long hole drill head of claim 3 wherein said ceramic material consists essentially of Al₂O₃ and/or ZrO₂.

5. The long hole drill head of claim 1 wherein said ceramic material is nitride based containing conventional pressing and/or sintering aids.

6. The long hole drill head of claim 5 wherein said nitride based material consists essentially of Si₃N₄.

7. The long hole drill head of claim 5 wherein said ceramic material consists of α- and/or β-sialon and intergranular phase.

8. The long hole drill head of claim 7 wherein said ceramic material further contains whiskers and/or platelets.

9. The long hole drill head of claim 8 wherein said whiskers and/or platelets comprise SiC.

10. The long hole drill head of claim 1 wherein said support pads are provided with a wear resistant coating.

11. Use of a long hole drill head of claim 1 for drilling in heat resistant superalloy materials.
